(19) United States
(12) Patent Application Publication
(10) Pub. No.: US 2019/0169927 A1
(43) Pub. Date: Jun. 6, 2019

(54) HANDLE ASSEMBLY FOR AN ARCHITECTURAL COVERING

(71) Applicant: Hunter Douglas Inc., Pearl River, NY (US)

(72) Inventor: Toralf H. Strand, Louisville, CO (US)

(73) Assignee: Hunter Douglas Inc., Pearl River, NY (US)

(21) Appl. No.: 16/269,402

(22) Filed: Feb. 6, 2019

Related U.S. Application Data
(63) Continuation of application No. 15/007,059, filed on Jan. 26, 2016.

(51) Int. Cl. E06B 9/388; E06B 9/262

(52) U.S. Cl. CPC E06B 9/388; E06B 2009/3222; E06B 9/262

(57) ABSTRACT

A handle assembly is provided. The handle may include first and second portions. The first portion may define a gripping feature and may include a rear surface. The second portion may extend from the rear surface of the first portion and may be configured to couple the handle to a rail of the architectural covering without the need for additional fixing elements.

### CROSS-REFERENCE TO RELATED APPLICATIONS

The present application is a continuation of co-pending U.S. patent application Ser. No. 15/007,059, filed on Jan. 26, 2016, and entitled “Handle Assembly for an Architectural Covering,” which application is hereby incorporated herein by reference in its entirety.

### TECHNICAL FIELD

This invention relates generally to coverings for architectural openings, and more specifically to a handle assembly for an architectural covering.

### BACKGROUND

Coverings for architectural openings, such as windows, doors, archways, and the like, have taken numerous forms for many years. Some coverings include a retractable shade member that is movable between an extended position and a retracted position. A rail typically is attached to an edge of the shade member to facilitate extension of the shade member across the opening and to maintain the shade member in a desired configuration. Some rails include a handle that facilitates a user moving the rail across the opening. Some handles may be unintentionally detached from the rail, are not aesthetically pleasing, or both.

### BRIEF SUMMARY

The present disclosure generally provides a handle assembly for an architectural covering that offers improvements or an alternative to existing arrangements. A compact handle may be provided on a rail of the covering for shipping purposes. If desired, the compact handle may be removed and replaced with an additional handle with a greater surface area for gripping, as typically provided on standard-sized handles. In order to simplify the installation process, the additional handle may be configured to be quickly and readily coupled to the rail, such as by being latched within a slot defined in a portion of the rail, with preferably minimal effort (e.g., no need for coupling elements or fasteners beyond just a mechanical engagement and interlocking of the handle and the rail, and no need for tools to achieve the connection between the handle and the rail). Either of the handles may be coupled to the rail such that the manner of coupling is not visually apparent. The coupling mechanism may permit the handle to be coupled to rails of various shapes and sizes (e.g., thicknesses).

A cover may be positioned over an exterior portion of the handle to modify the desired aesthetic and/or functional characteristics of the handle. In some embodiments, the handles and cover may be included in a kit, which may provide alternative gripping features for a rail. Such kit may be provided with the architectural covering when shipped to a location for installation of the architectural covering.

This summary of the disclosure is given to aid understanding, and one of skill in the art will understand that each of the various aspects and features of the disclosure may advantageously be used separately in some instances, or in combination with other aspects and features of the disclosure in other instances. Accordingly, while the disclosure is presented in terms of embodiments, it should be appreciated that individual aspects of any embodiment can be claimed separately or in combination with aspects and features of that embodiment or any other embodiment. The present disclosure of certain embodiments is merely exemplary in nature and is in no way intended to limit the claimed invention or its applications or uses. It is to be understood that other embodiments may be utilized and that structural and/or logical changes may be made without departing from the spirit and scope of the present disclosure.

The present disclosure is set forth in various levels of detail in this application and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. It should be understood that the claimed subject matter is not necessarily limited to the particular embodiments or arrangements illustrated herein, and the scope of the present disclosure is defined only by the appended claims.

### BRIEF DESCRIPTION OF THE DRAWINGS

The accompanying drawings, which are incorporated into and constitute a part of the specification, illustrate embodiments of the present disclosure by way of illustration only and, together with the general description above and the detailed description below, serve to explain the principles of the present disclosure.

FIG. 1 is a front isometric view of a covering in accordance with an embodiment of the present disclosure.

FIG. 2 is a front exploded view of a handle assembly and a rail in accordance with an embodiment of the present disclosure.

FIG. 3 is a top isometric view of a plug handle in accordance with an embodiment of the present disclosure.

FIG. 4 is a top isometric view of a handle in accordance with an embodiment of the present disclosure.

FIG. 5 is an enlarged, side elevation view of the handle of FIG. 4 in accordance with an embodiment of the present disclosure.

FIG. 6 is an enlarged, cross-sectional view of the covering of FIG. 1 taken along line A-A of FIG. 1 in accordance with an embodiment of the present disclosure.

FIG. 6A is an enlarged, detail view taken along line B-B of FIG. 6 in accordance with an embodiment of the present disclosure.

FIG. 6B is an additional enlarged, detail view taken along line B-B of FIG. 6 in accordance with an embodiment of the present disclosure.

FIG. 6C is an additional enlarged, detail view taken along line B-B of FIG. 6 in accordance with an embodiment of the present disclosure.

FIG. 7 is an additional enlarged, cross-sectional view of the covering of FIG. 1 taken along line A-A of FIG. 1 in accordance with an embodiment of the present disclosure.

### DETAILED DESCRIPTION

In accordance with various principles of the present disclosure, a handle is coupled to an architectural covering, typically to a rail of the architectural covering. In one embodiment, the handle is releasably coupled to a portion of the covering, such as a rail, in a manner that permits quick interchangeability of different handles. In accordance with another independent aspect of the disclosure, a compact handle may be provided on the covering, such as for shipping purposes. The compact handle may have a gripping surface reduced from the standard size for gripping surfaces for a handle so that the compact handle does not protrude as far from the covering/rail as a standard handle would, and is less likely to engage another element, and possible get caught or even break off. An additional handle, preferably providing greater surface area for gripping, as typically provided on standard-sized handles, may be provided to replace the compact handle, the compact handle in such case preferably being readily removable from the rail. In order to simplify the installation process, either handle, and preferably at least the additional handle, may be configured to be quickly and readily latched to the rail within a slot defined in a portion of the rail with preferably minimal effort (e.g., no need for coupling elements or fasteners, such as screws, beyond just a mechanical engagement and interlocking of the handle and the rail, and no need for tools to achieve the connection between the handle and the rail). Either of the handles may be coupled to the rail such that the manner of coupling is not visually apparent. The coupling mechanism may permit the handle to be coupled to rails of various shapes and sizes (e.g., thicknesses). In one embodiment, separate and independent from the aforementioned embodiment yet combinable therewith if desired, the handle is coupled to the covering in a manner that conceals the coupling structure, thereby resulting in a smooth, “clean,” or streamlined appearance, with the handle engaged to a portion of the covering, such as the rail, such that the engagement is not evident to an observer once coupling is achieved.

In one embodiment separate and independent from the aforementioned embodiment yet combinable therewith if desired, a cover may be provided to be fitted over an exterior portion of the handle to modify the aesthetic and/or functional characteristics of the handle.

In some embodiments, the handles and cover may be included in a kit which may be provided with the architectural covering when shipped to a location for installation of the architectural covering. As such, a handle may be pre-installed on the rail of the architectural covering for use as desired. If the initially-installed handle is not large enough (e.g., somewhat stubby, or shorter than a standard handle, providing less gripping surface area than provided on standard handles), or otherwise is not desired, the initially-installed handle may be removed and replaced with another replacement handle. The handle of the architectural covering may be further altered by placing a covering over the replacement handle, such as to alter the aesthetics and/or functional characteristics of the handle.

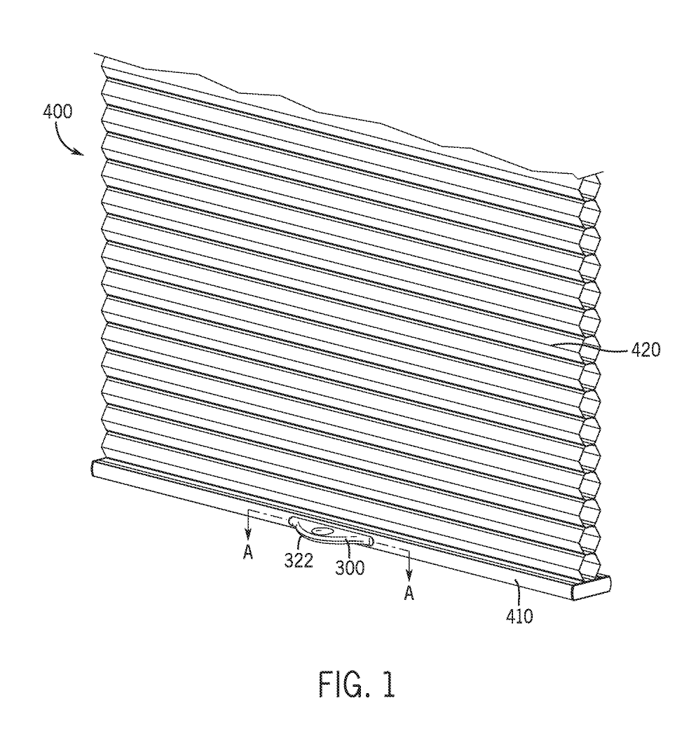

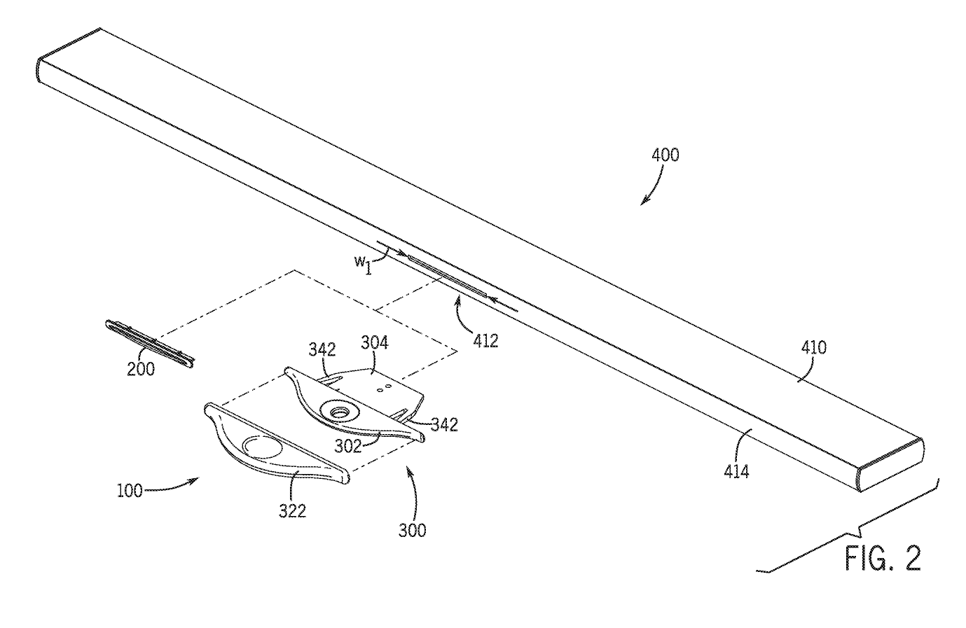

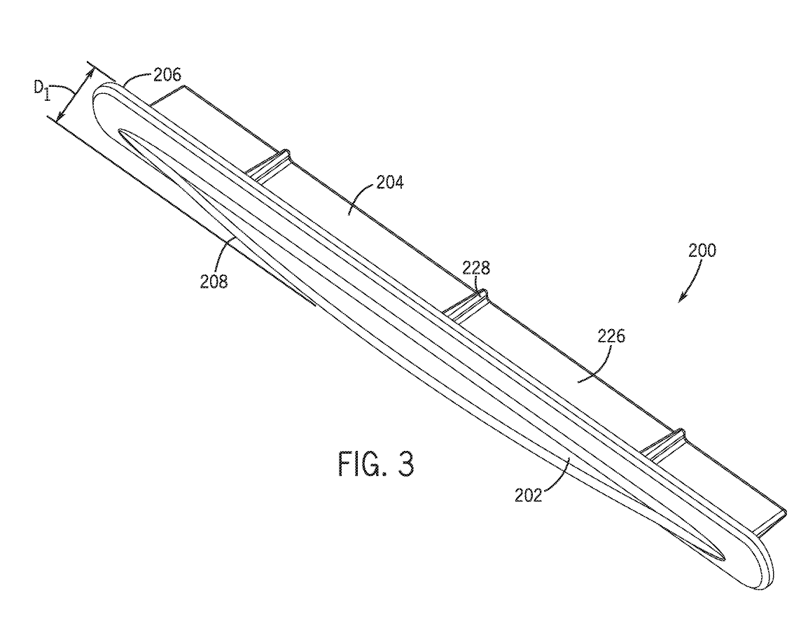

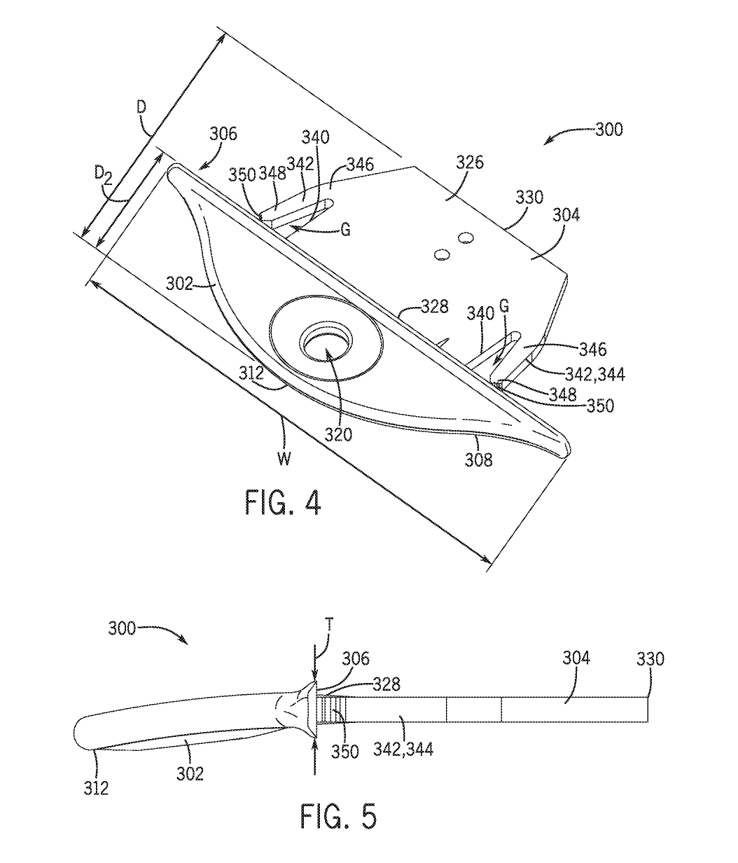

FIG. 2 illustrates an example of a handle kit 100 providing a handle 300 for use with a covering 400 as illustrated in FIG. 1. Referring now to FIGS. 2 and 3, when the handle 300 is not coupled to a rail 410 of the covering 400 (as illustrated in FIG. 1), a plug handle 200 may be inserted at least partially within the slot 412 to, for example, provide an alternative handle assembly for the rail 410. The plug handle 200, which may alternatively be referred to as a first or second handle, a removable handle, or any combination thereof, may be dimensionally sized to frictionally engage the slot 412. Referring to FIG. 3, the plug handle 200 may include first and second portions 202, 204. The first portion 202, which may be referred to as an exterior portion, a gripping portion, a first or second portion, a front portion, or any combination thereof, may be operable to be positioned on an exterior portion of the rail 410. The second portion 204, which may be referred to as an interior portion, a first or second portion, a rear portion, or any combination thereof, may extend from a rear surface 206 of the first portion 202 of the plug handle 200 and may be operable to be inserted at least partially within the slot 412. The first portion 202 of the plug handle 200 may include dimensions larger than the slot 412 to conceal the slot 412 from view but may be sized smaller than the first portion 302 of the handle 300. For example, the first portion 202 of the plug handle 200 may include a first depth D₁ extending from its rear surface 206 to an outermost extent of a lip 208 defined in the first portion 202 extending away from the rear surface 206. Similarly, with reference to FIG. 4, a first portion 302 of the handle 300 may include a second depth D₂ extending from a rear surface 306 of the handle 300 to an outermost extent of the first portion 302 of the handle 300 (e.g., to a middle portion 312). In such embodiments, the second depth D₂ may be greater than the first depth D₁. As such, the plug handle 200 extends a shorter distance away from the rail 410, which may be desirable for various reasons, such as to facilitate shipping, or to provide a sleeker appearance when the covering 400 is in use. Furthermore, the first portion 202 of the plug handle 200 may provide a gripping feature different from the gripping feature provided by the handle 300. For example, the gripping feature provided by the plug handle 200 may provide a smaller gripping surface area than the gripping surface area provided by the gripping feature of the handle 300.

Referring back to FIG. 3, the lip 208 on the first portion 202 of the plug handle 200 may be sized and shaped so as to be non-obtrusive (e.g., substantially flush with the rail 410) while simultaneously providing some degree of gripping feature. The second portion 204 of the plug handle 200 may include a plank 226 cantilevered from the rear surface 206 of the first portion 202 of the plug handle 200. A plurality of gussets 228 may extend from the plank 226 and, in some embodiments, may be connected to both the plank 226 and the rear surface 206. The gussets 228 may increasingly taper in height as the gussets 228 extend towards the rear surface 206 of the plug handle 200 to provide sufficient friction between the gussets 228 and the portion of the front wall 414 of the rail 410 defining the periphery of the slot 412 as the plug handle 200 is inserted therein. Such coupling of the plug handle 200 to the rail 410 is relatively simple, does not require tools, and does not require additional coupling elements. Additionally, such coupling also permits the plug handle 200 to be removed from the rail 410 without the use of a tool, and without damaging the rail 410.

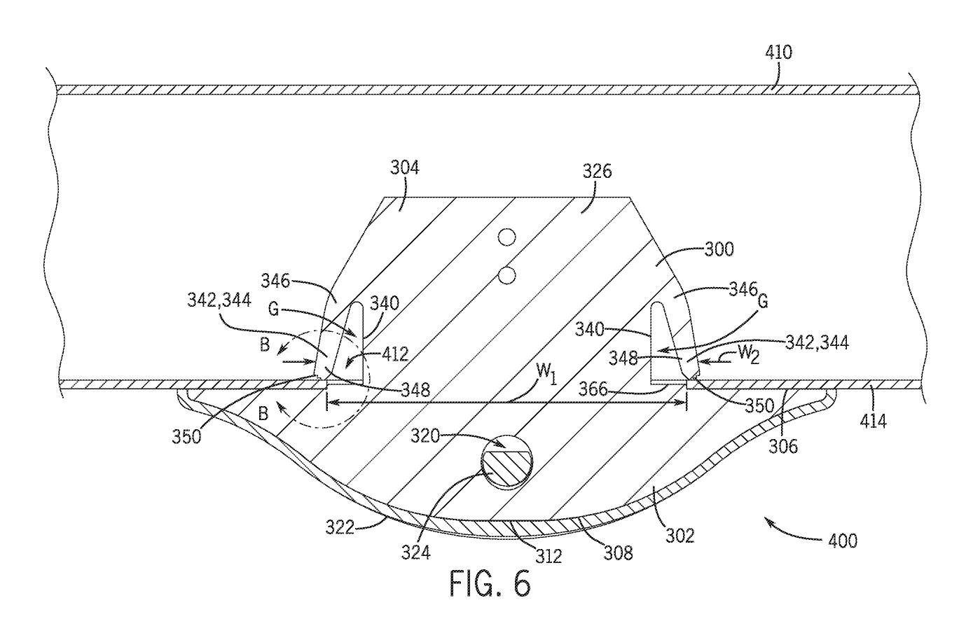

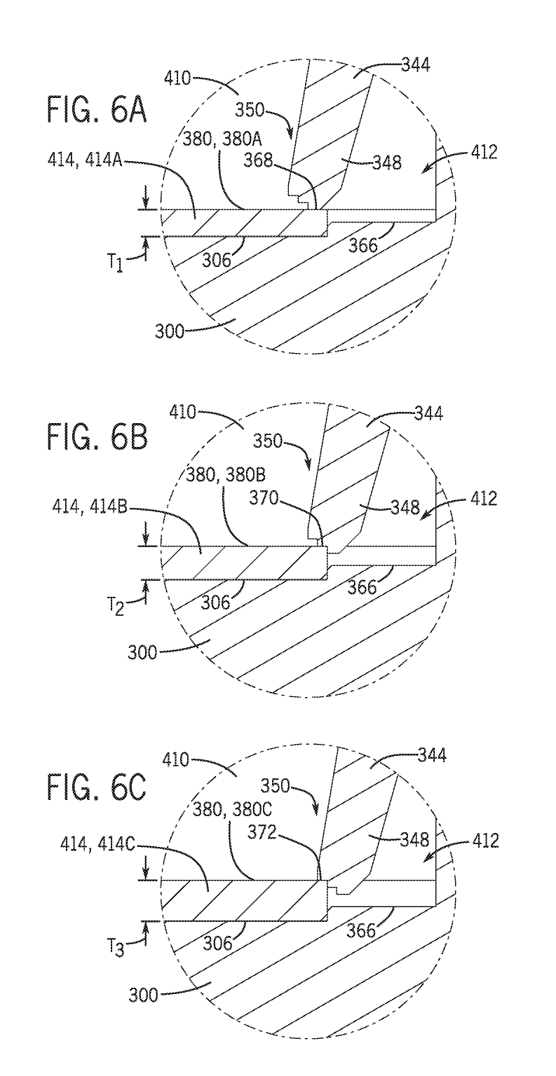

Referring to FIGS. 4 and 5, the handle 300 according to one embodiment of the present disclosure includes first and second portions 302, 304 collectively defining a depth D, a transverse width W (see FIG. 4), and a thickness T (see FIG. 5) of the handle 300 such that the handle 300 may be considered wide and thin. The first portion 302, which may be referred to as an exterior portion, a gripping portion, a first or second portion, a front portion, or any combination thereof, may define a gripping feature and may include a rear surface 306 from which the second portion 304 extends. As best seen in FIGS. 4 and 6, the shape of the first portion 302 may be defined by a substantially planar rear surface 306 and a front edge 308 extending from the rear surface 306 adjacent the periphery of the first portion 302 defining the width W of the handle 300. As illustrated, the front edge 308 may extend from the rear surface 306 at an acute angle, thereby resulting in a smooth, clean, or streamlined transition between the handle 300 and an associated covering 310 for an architectural opening, such as a window, door, archway, or the like (see FIG. 1). The front edge 308 may be curved such that a middle portion 312 of the front edge 308 is spaced further from the rear surface 306 than the portions of the front edge 308 adjacent the periphery of the first portion 302 defining the width W of the handle 300. In one embodiment, the first portion 302 may include an aperture 320 defined therethrough adjacent the middle portion 312 of the front edge 308 for the purposes explained below. In some embodiments, the aperture 320 may be operable to engage a pole operable to guide and/or move the covering 310 between extended and retracted positions.

With reference to FIGS. 4 and 5, the first portion 302 of the handle 300 may be sized and shaped to achieve a desired aesthetic and/or functional characteristic. For example, the first portion 302 may be curved such that a portion of the front edge 308 (e.g., the middle portion 312) is positioned at least partially below the rear surface 306 and/or the second portion 304 (see FIG. 5). In this manner, the handle 300 may provide a gripping feature (e.g., a lip) for a user to firmly grasp the handle 300 for manipulation thereof. The first portion 302 may be smooth to provide a desired aesthetic characteristic and/or increase a user's comfort in grasping the handle 300. As detailed below, in one exemplary embodiment, the rear surface 306 may include dimensions larger than the second portion 304 extending therefrom such that the second portion 304 is concealed when the handle 300 is coupled to the covering 310, for instance.

The handle 300 is sufficiently wide and includes a sufficient depth D₂, as may be appreciated with reference to FIG. 2 and comparison with plug handle 200, to provide a sufficient grip for an average adult user (e.g., sufficient surface area to permit gripping by standard dimensions of adult fingers, such as the thumb). However, it may be desirable for a handle 300 with at least such a depth D₂ to not be provided on the rail 410 during shipping. As such, the handle receiving slot 412 in the rail 410 may be left without a handle coupled thereto. Alternatively, a handle with smaller dimensions, such as the alternate handle 200, referenced as plug handle 200 herein for the sake of simplicity for differentiating from the handle 300 and without intent to limit, may be coupled to the rail 410, such as via coupling to or within the slot 412.

Depending on user preference, either the handle 300 or the plug handle 200 may be connected to the rail 410 in an interchangeable manner. In this way, both the handle 300 and the plug handle 200 may be provided in a kit 100 associated with the rail 410 and/or the covering 400 (see FIG. 2). For example, the kit 100 may be packaged to include the handle 300, the plug handle 200, and at least one cover member 322. In some embodiments, the kit 100 may also include the rail 410, which may be included as part of the covering 400. Additionally or alternatively, the rail 410, whether connected to a shade member 420 or not, may be shipped to a customer or user with the plug handle 200 inserted within the slot 412. Upon receipt of the rail 410, the customer or user may remove the plug handle 200 and couple the handle 300 to the rail 410. In this manner, shipping damage to the handle 300, which may occur when the handle 300 is connected to the rail 410 during shipping, may be minimized. For example, the plug handle 200 may be sufficiently compact or non-obtrusive such that its gripping feature (i.e., the lip 208) is less susceptible to breaking off during shipping than a longer handle or grip element. The lip 208 may be sufficiently long so the plug handle 200 may be used as the actual handle during operation of the covering 310. However, if the user/customer desires a larger gripping surface, the plug handle 200 may be readily removed (e.g., because of the interference fit directly between the plug handle 200 and the rail 410, which does not require additional fixing elements) and replaced with the handle 300 exemplifying a more typical handle assembly with more typical dimensions providing a more typical gripping surface.

In some embodiments, the handle 300 and the plug handle 200 may engage the rail 410 such that the coupling is not visually apparent. For example, the rear surfaces 306, 206 of each of the handle 300 and the plug handle 200 may be adapted to abuttingly engage a surface (e.g., a front surface of the front wall 414) of the rail 410 in which the slot 412 is defined. As noted herein, the rear surfaces 306, 206 may include dimensions greater than the slot 412 such that the slot 412 is concealed once the handle 300 is coupled to the rail 410. The abutment of surfaces, rather than interconnection of surfaces, may result in a smoother uninterrupted appearance.

With reference to FIGS. 2 and 6, the handle kit 100, which may alternatively be referred to as a handle assembly, may include a cover member 322 operable to selectively cover and substantially conceal at least the first portion 302 of the handle 300. The interior of the cover member 322 may be sized and shaped to compliment the size and shape of the first portion 302 of the handle 300. The cover member 322 may be deformable and may, in some embodiments, include structure engageable with the aperture 320 to selectively secure the cover member 322 to the first portion 302 of the handle 300. For instance, as best seen in FIG. 6, at least one post 324 may extend within the interior of the cover member 322 for at least partial corresponding engagement with the aperture 320 defined in the first portion 302 of the handle 300. In this manner, the engagement of the post 324 within the aperture 320 may selectively secure the cover member 322 to the handle 300. In such embodiments, a user may attach different cover members 322 of varying shapes, sizes, materials, colors, and/or textures, among others, to the handle 300 depending on a desired aesthetic and/or functional characteristic. For instance, the various cover members 322 may be color coordinated with the covering 310 and may provide various levels of friction depending on the particular application. The cover member 322 may alter the characteristics of the handle 300. Such characteristics may include, without limitation, color, texture (e.g., contour or feel, such as a rubberized material in contrast with a lower-friction material such as plastic), shape, etc.

With reference to FIGS. 4 and 6, the second portion 304 of the handle 300, which may be referred to as an interior portion, a first or second portion, a rear portion, or any combination thereof, may be sized and shaped to operably couple the handle 300 to the covering 400. For example without limitation, the second portion 304 may be a substantially planar member having a main body 326 defined at least partially by opposing first and second edges 328, 330 (see FIGS. 4 and 5) and opposing side edges 340 extending between the opposing first and second edges 328, 330. In such embodiments, the first edge 328 may be attached or otherwise coupled to the rear surface 306 of the first portion 302 of the handle 300 such that the second portion 304 is cantilevered from the rear surface 306. Depending on the particular application, the second portion 304 may extend at a substantially right angle relative to the rear surface 306 of the first portion 302 (see FIG. 5). In one embodiment, the second portion 304 may include a plurality of resilient coupling mechanisms 342 operable to secure the handle 300 to the rail 410, such as through snap fit or latching engagement. The coupling mechanisms 342 may extend away from the opposing side edges 340 of the main body 326. For example, as illustrated in FIGS. 4 and 5, the coupling mechanisms 342 may extend laterally from the opposing side edges 340 such that the coupling mechanisms 342 and the main body 326 lie in substantially the same plane. As best seen in FIGS. 4 and 6, the coupling mechanisms 342 may define a gap G between a portion of each coupling mechanism 342 and one of the opposing side edges 340. As more fully explained below, the gap G may permit at least a portion of the coupling mechanisms 342 to bend, collapse, or otherwise deform, such as inwardly towards the opposing side edges 340, to allow the handle 300 to be releasably latched or otherwise coupled to a portion of the covering 310.

As illustrated in FIGS. 4 and 6, each of the coupling mechanisms 342 may take the form of a resilient tab 344 cantilevered from one of the opposing side edges 340. Each tab 344 may extend from one of the opposing side edges 340 towards the rear surface 306 of the first portion 302 of the handle 300. In such embodiments, each tab 344 may include opposing first and second ends 346, 348, the first end 346 attached to an opposing side edge 340 of the second portion 304 to space the second end 348 away from the opposing side edge 340 to define the gap G therebetween. In such embodiments, each tab 344 may resiliently move (e.g., bend) such that the second end 348 of the tab 344 moves (e.g., translates) towards an adjacent opposing side edge 340 to decrease the size of the gap G and thereby couple the handle 300 to, or remove the handle 300 from, the covering 310, as explained in more detail below. As illustrated, the second end 348 of each tab 344 may include an engagement feature 350 to accommodate the handle 300 to be secured to coverings 310 having varying dimensions, as explained more fully below.

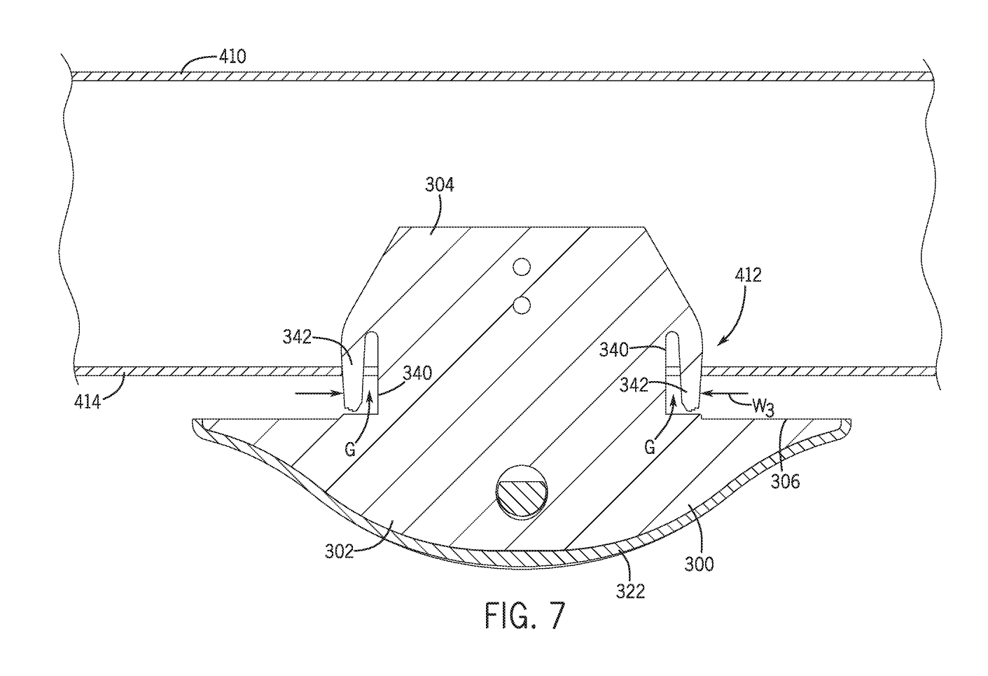

With reference to FIGS. 1, 2, 6, and 7, the handle 300 may be releasably coupled to a portion of the covering 310 to facilitate movement of the covering 310 between extended and retracted positions covering or uncovering the architectural opening. In one embodiment, the covering 310 may include a shade member 420 and a rail 410 to which the handle 300 and the shade member 420 are attached. The rail 410, which may be a bottom rail, a middle rail, or a top rail, among others, may include an elongated slot 412 defined in a portion (e.g., a front wall 414) of the rail 410, the slot 412 having dimensions to allow deformable insertion of the second portion 304 of the handle 300 therethrough. In this manner, the handle 300 may be at least partially received within the slot 412 to releasably couple the handle 300 to the rail 410 without the use of additional fixing elements. For example, the handle 300 and the rail 410 may interlock or otherwise engage such that the handle 300 and the rail 410 fit together to secure the handle 300 to the rail 410 so that an additional step, such as using an additional fixing element, is not required. In some embodiments, the coupling mechanisms 342 may define a variable width of the second portion 304 of the handle 300 such that the handle 300 may be coupled to the rail 410, such as through snap fit or latching engagement. For example, in one embodiment the slot 412 defines a first width W₁ (see FIG. 2), and the variable width of the second portion 304 of the handle 300 includes second and third widths W₂, W₃ (see FIGS. 6 and 7, respectively). In such embodiments, the second width W₂ may be greater than the first width W₁ to secure the handle 300 to the rail 410 (see FIG. 6), and the third width W₃ may be less than the first width W₁ to, for example, permit coupling of the handle 300 to, or removal of the handle 300 from, the rail 410. For instance, each gap G may be sized to permit at least a portion of each coupling mechanism 342 to deform inwardly towards an adjacent opposing side edge 340 to permit insertion and/or removal of the second portion 304 of the handle 300 through and/or from the slot 412 (see FIG. 7), as explained more fully below. In such embodiments, when the handle 300 is coupled to the rail 410, a portion of the front wall 414 of the rail 410 may be positioned between the rear surface 306 and the coupling mechanisms 342, such as between the rear surface 306 and the second end 348 of each tab 344 (see FIG. 6).

Referring to FIG. 6, to limit movement of the handle 300 relative to the rail 410, the second portion 304 may include at least one base 366 extending from the rear surface 306 of the first portion 302 of the handle 300 adjacent (e.g., connected to) at least one of the opposing side edges 340, the base 366 in conjunction with the main body 326 of the second portion 304 may define a width substantially equivalent to the first width W₁ of the slot 412. When the handle 300 is coupled to the rail 410, the base 366 may extend within the slot 412 to limit lateral movement of the handle 300 relative to the rail 410. In one embodiment, the base(s) 366 may extend only partially within the slot 412 so as to not limit the resilient movement of the coupling mechanisms 342 (see FIG. 7).

As best seen in FIGS. 6A-6C, the engagement feature 350 of each tab 344 may include a plurality of steps (e.g., a first step 368, a second step 370, a third step 372, etc.) defined in the second end 348 of each tab 344 to permit, for example, the handle 300 to be secured to rails 410 having a front wall 414 of different shapes and sizes (e.g., thicknesses). For example, the first step 368 may engage an inner surface 380 of a front wall 414 having a first thickness T₁ (such as inner surface 380A of front wall 414A shown in FIG. 6A), the second step 370 may engage an inner surface 380 of a front wall 414 having a second thickness T₂ (such as inner surface 380B of front wall 414B shown in FIG. 6B), the third step 372 may engage an inner surface 380 of a front wall 414 having a third thickness T₃ (such as inner surface 380C of front wall 414C shown in FIG. 6C), and so on, the third thickness being greater than the second thickness, the second thickness being greater than the first thickness, etc. Additionally or alternatively, the stepped nature of the second end 348 of each tab 344 may allow the tabs 344 to clear the front wall 414 of the rail 410 during coupling while also providing sufficient contact between the tabs 344 and the front wall 414 to secure the handle 300 to the rail 410.

To couple the handle 300 to the rail 410, the handle 300 may be positioned adjacent the rail 410 so the second portion 304 is in alignment with the slot 412. The second portion 304 of the handle 300 may then be inserted at least partially into the slot 412. As best seen in FIG. 7, insertion of the second portion 304 of the handle 300 within the slot 412 collapses, bends, or otherwise deforms the coupling mechanisms 342 sufficiently to permit passage of the second portion 304 of the handle 300 through the slot 412 and into an interior of the rail 410. Once the coupling mechanisms 342 clear the front wall 414 of the rail 410, the coupling mechanisms 342 may expand outwardly to releasably couple at least a portion of the coupling mechanisms 342 (e.g. the second end 348 of each tab 344) against the inner surface 380 of the front wall 414 of the rail 410 (see FIGS. 6-6C). Once the handle 300 is coupled to the rail 410, at least a portion of the front wall 414 of the rail 410 may be sandwiched between the rear surface 306 of the handle 300 and the coupling mechanisms 342.

Releasing the handle 300 from the rail 410 may be accomplished in substantially reverse order as that described above. In particular, a user may first depress the coupling mechanisms 342, such as via access to the second portion 304 from within the interior of the rail 410, to decrease the size of the gap G sufficiently to permit removal of the handle 300. For example, the user may depress the coupling mechanisms 342 until the width of the second portion 304 is less than the width of the slot 412. Once the gap G is sufficiently decreased, the user may then remove the handle 300 from the slot 412 by pulling or otherwise moving the handle 300 away from the rail 410 (see FIG. 7).

The handle 300, the cover member 322, the rail 410, and the plug handle 200 may be constructed of substantially any type of material. For example, the handle 300, the rail 410, and the plug handle 200 may be constructed or formed from natural and/or synthetic materials, including metals, ceramics, plastics, vinyl, and/or other suitable materials. Plastic materials may include thermoplastic material (self-reinforced or fiber-reinforced), ABS, polycarbonate, polypropylene, polystyrene, PVC, polyamide, or PTFE, among others. The cover member 322 may be constructed or formed from natural and/or synthetic deformable materials, including vinyl, plastics, leather, and fabrics.

The foregoing description has broad application. It should be appreciated that the concepts disclosed herein may apply to many types of shades, in addition to the shades described and depicted herein. Similarly, it should be appreciated that the concepts disclosed herein may apply to many types of rails, in addition to the rail 410 described and depicted herein. For example, the concepts may apply equally to any type of rail, such as a rail which is movable through use of a handle assembly. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

The phrases “at least one”, “one or more”, and “and/or”, as used herein, are open-ended expressions that are both conjunctive and disjunctive in operation. The term “a” or “an” entity, as used herein, refers to one or more of that entity. As such, the terms “a” (or “an”), “one or more” and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may vary.

1. An architectural covering comprising:
a shade member adapted and configured to be moved between an extended position and a retracted position, said shade member including a height, a width, a front surface, and a rear surface; and
a rail attached to said shade member and including a front wall having a front surface corresponding to said front surface of said shade member, a rear wall having a rear surface corresponding to said rear surface of said shade member, and an elongated slot defined through said front wall of said rail;
wherein said elongated slot is dimensioned and configured to receive a substantially planar component of a handle such that insertion of said planar component into said elongated slot couples said handle to said rail without use of additional coupling elements.

2. The architectural covering of claim 1, wherein said handle is selected from one of a first, plug type handle and a second, gripping handle that is sized and configured differently from said first, plug type handle.

3. The architectural covering of claim 2, wherein:
each of said first, plug type handle and said second, gripping handle includes a first portion arranged and configured to be gripped by a user, and a second portion extending from a rear surface of said first portion, said second portion including said planar component;
said planar component of said first, plug type handle is arranged and configured to be inserted into said elongated slot independent of said planar component of said second, gripping handle; and
said planar component of said second, gripping handle is arranged and configured to be inserted into said elongated slot independent of said planar component of said first, plug type handle so that said first and second handles are selectively and independently inserted into said elongated slot.

4. The architectural covering of claim 2, wherein said handle is said first, plug type handle, said plug type handle including a first portion and a second portion extending from a rear surface of said first portion, said second portion including said planar component, said planar component being dimensionally sized to frictionally couple said elongated slot so that said plug type handle is coupled to said rail without use of additional coupling elements.

5. The architectural covering of claim 4, wherein said first portion is dimensionally sized to conceal said elongated slot when said plug type handle is coupled to said rail.

6. The architectural covering of claim 4, wherein said rear surface of said plug type handle is arranged and configured to abuttingly contact said front surface of said rail, said rear surface being arranged and configured to conceal said elongated slot so that said elongated slot is concealed when said plug type handle is coupled to said rail.

7. The architectural covering of claim 4, wherein said planar component of said plug type handle includes a plank and a plurality of gussets extending from said plank.

8. The architectural covering of claim 2, wherein said handle is said second, gripping handle, said gripping handle including a first portion and a second portion extending from a rear surface of said first portion, said second portion including said planar component, said planar component including a deformable section arranged and configured to deform upon insertion into said elongated slot to hold said gripping handle to said rail without any additional coupling elements.

9. The architectural covering of claim 8, wherein said first portion of said gripping handle is dimensionally sized to conceal said elongated slot when said gripping handle is coupled to said rail.

10. The architectural covering of claim 9, wherein said rear surface of said gripping handle is adapted and configured to abuttingly contact said front surface of said rail, said rear surface being sized and configured to conceal said elongated slot when said gripping handle is coupled to said rail.

11. The architectural covering of claim 8, wherein said planar component of said gripping handle includes a variable width such that said gripping handle is adapted and configured to latching engage said rail.

12. The architectural covering of claim 11, wherein:
said elongated slot includes a first width; and
said variable width of said planar component of said gripping handle includes a second width and a third width, said second width of said variable width of said planar component of said gripping handle being less than said first width of said elongated slot; and
said third width of said variable width of said planar component of said gripping handle being greater than said first width of said elongated slot to secure said second handle to said rail.

13. The architectural covering of claim 8, wherein:
said elongated slot includes a first width and a relatively narrow height;
said planar component of said gripping handle includes a pair of resiliently deformable coupling mechanisms configured such that upon insertion of said resiliently deformable coupling mechanisms within said elongated slot said gripping handle is coupled to said rail.

14. The architectural covering of claim 13, wherein said pair of resiliently deformable coupling mechanisms extend laterally from said planar component of said gripping handle to define a variable width of said planar component of said gripping handle, said variable width varying between a first width and a second width, said first width being sized for insertion of said planar component of said gripping handle through said elongated slot, said second width being larger than said first width such that upon insertion of said resiliently deformable coupling mechanisms through said elongated slot said resiliently deformable coupling mechanisms contact an inner surface of said rail.

15. An architectural covering including a shade member adapted and configured to be moved between an extended position and a retracted position, the architectural covering comprising:
a rail including a top surface adapted and configured to be coupled with a portion of the shade member and a front wall having a front surface transverse to said top surface, said front wall including an elongated slot defined therethrough; and
a handle selected from one of a first handle and a second handle, said first handle including a first interior portion adapted and configured for insertion into said elongated slot and a first exterior portion extending from the first interior portion for gripping by a user; said second handle including a second interior portion adapted and configured for insertion into said elongated slot and a second exterior portion extending from the second interior portion for gripping by the user;
wherein:
said first exterior portion has a first depth front to back in a direction transverse to said rail, said second exterior portion has a second depth front to back in a direction transverse to said rail that is significantly greater than the first depth;
said elongated slot is dimensioned and configured to receive either (1) said first interior portion of said first handle for coupling said first handle to said rail; or (2) said second interior portion of said second handle for coupling said second handle to said rail;
said elongated slot is configured to receive the first interior portion of the first handle independent of the second interior portion of the second handle; and
said elongated slot is configured to receive the second interior portion of the second handle independent of the first interior portion of the first handle so that said elongated slot independently receives either the first or the second handle.

16. The architectural covering of claim 15, wherein said first exterior portion of said first handle is substantially flush with said rail when said first interior portion of said first handle is inserted into said slot.

17. The architectural covering of claim 15, wherein:
said first interior portion of said first handle includes a first coupling mechanism arranged and configured to be selectively inserted and removed from said slot in said rail; and
said second handle includes a second coupling mechanism different from said first coupling mechanism, said second coupling mechanism is adapted and configured so that insertion of said second interior portion into said slot snap fits said second handle to said rail.

18. The architectural covering of claim 17, wherein:
said first interior portion of said first handle is adapted and configured to frictionally couple said first handle to said rail upon insertion within said slot; and
said second interior portion of said second handle is adapted and configured to couple said second handle to said rail upon insertion through said slot such that a portion of said second interior portion contacts an inner surface of said rail.
